(19) United States
(12) Patent Application Publication
(10) Pub. No.: US 2007/0168304 A1
(43) Pub. Date: Jul. 19, 2007

(54) Method of financing mobile assets

(76) Inventor: Paul Michael Hletko, Chicago, IL (US)

Correspondence Address: Paul M. Hletko, 5412 N. Glenwood #2, Chicago, IL, 60640, US

(21) Appl. No.: 11/334,251

(22) Filed: Jan. 18, 2006

(51) Int. Cl. G06F 17/00

(52) U.S. Cl. 705/400

(57) ABSTRACT

A method of deploying a mobile asset includes assigning a priority factor to a plurality of users and determining departure information for each of the users. The method further includes determining a movement information associated with each departure information and deploying the asset based on the departure information, movement information and priority factors. An alternate method of operating a mobile asset includes determining departure information for at least one user and determining a movement information associated with each departure information. The alternate method includes determining a cost of at least one alternative, deploying the asset based on the departure information, movement information and cost of at least one alternative, and charging at least one client based on the cost of at least one alternative.

### FIELD OF THE INVENTION

This invention generally relates to the art of financing purchases. More particularly, the invention relates to financing mobile assets.

### BACKGROUND OF THE INVENTION

Many professionals travel extensively in pursuit of their clients' interests. Similarly, many businesses employ professionals, such as attorneys, that travel extensively in pursuit of the business' interests. For example, many attorneys spend significant time traveling to and from depositions and court appearances. Often, these professionals travel using commercial services, such as a common carrier. Common carriers include commercial airlines.

Other times, cars are the preferred travel mode. While many professionals own their own vehicles, the expenses of operating a private vehicle on behalf of a client (i.e. mileage charges, etc.) often result in the professional renting a vehicle in an effort to minimize expenses.

Such travel arrangements, especially using commercial air travel, present many difficulties. First, the cost of commercial air travel is high, and is an expense rather than an investment. Second, use of commercial air travel can be inconvenient and time consuming, as commercial air travel schedules are not arranged around the professional's schedule. Further, there is a need to arrive at the airport quite early to get through lines and security.

Fractional ownership and charter programs attempt to satisfy the need, but each have downsides. Fractional ownership remains expensive and many fractional ownership programs do not truly provide the benefits of ownership. Charters can be similarly expensive with service constraints.

Businesses generally prefer to avoid expenses, and one attempt to avoid expenses is to attempt to minimize expenses. To this aim, many clients will not reimburse for, for example, first class air tickets. However, such an effort does not turn an expense into an asset. The present invention advances the art.

### BRIEF SUMMARY OF THE INVENTION

A method of deploying a mobile asset includes assigning a priority factor to a plurality of users and determining departure information for each of the users. The method further includes determining a movement information associated with each departure information and deploying the asset based on the departure information, movement information and priority factors.

An alternate method of operating a mobile asset includes determining departure information for at least one user and determining a movement information associated with each departure information. The alternate method includes determining a cost of at least one alternative, deploying the asset based on the departure information, movement information and cost of at least one alternative, and charging at least one client based on the cost of at least one alternative.

A system of operating a mobile asset in accordance with another aspect of the invention includes means for determining departure information at least one user and means for determining a movement information associated with each departure information. The system further includes means for determining a cost of at least one alternative, means for deploying the asset based on the departure information, and means for charging at least one client based on the cost of at least one alternative.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates one aspect of a method of deploying a mobile asset in accordance with one aspect of the invention;

FIG. 2 illustrates one aspect of a method of deploying a mobile asset in accordance with one aspect of the invention;

FIG. 3 illustrates one aspect of a method of deploying a mobile asset in accordance with one aspect of the invention; and

FIG. 4 illustrates one aspect of a method of deploying a mobile asset in accordance with one aspect of the invention.

### DETAILED DESCRIPTION

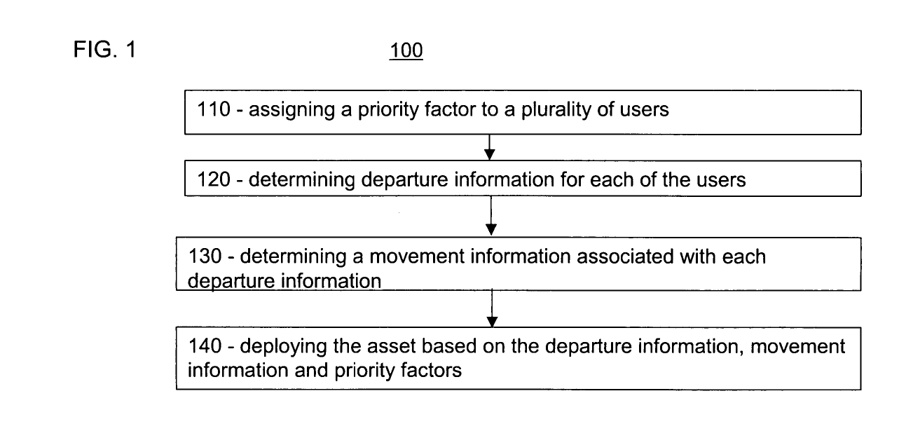

FIG. 1 illustrates one aspect of a method 100 of deploying a mobile asset in accordance with one aspect of the invention.

Method 100 is applied to assign use of a limited asset capable of providing transportation to passengers or users. The asset can be any motorized or non-motorized vehicle or implement. However, for sake of clarity, the invention will be described with reference to an airplane or aircraft. Such a description should not be taken as limiting, but rather explanatory, and the teachings and claims of this disclosure are equally as applicable to other motor vehicles such as automobiles, boats, and motorcycles, as well as non-motorized vehicles such as bicycles, sailboats, rickshaws and the like.

Method 100 begins at 110 by assigning a priority factor to a plurality of users. A priority factor is applied to rank users by the desirability of assigning use of the asset to that user. For example, the owner of a business may be assigned a higher priority than a junior employee. In another example, a partner of a law firm is assigned a higher priority factor than an associate. A priority factor can be assigned to a single user, or a plurality of users that will use the asset as a group, such as a number of coworkers that are traveling together to the same destination or sharing at least a portion of a common itinerary. In one embodiment, the priority factor for each user is incremented based on a total number of users that can simultaneously use the asset. In one embodiment, the priority factor is established based on the number of users associated with the departure information. In another embodiment, the priority factor is based on the identity of the user. In yet another embodiment, the priority factor is adjusted based on a revenue associated with the user.

Departure information is determined for each user at step 120. Departure information includes any information relating to a user's departure. Departure information includes a user's current city, a desired departure time, a desired destination, a desired arrival time, a number of users

A movement information is determined at step 130. Movement information is defined as any movement of the asset required to transport each user in accordance with their associated departure information and arrival information. In one embodiment, a cost information is also determined and associated with the movement information. For example, a cost per hour of asset operation is determined. For example, if a user is located in Chicago, Ill. and the asset is located in Miami, Fla., the movement information determined would, for example, include the time associated with moving the asset from Miami to Chicago, as well as the cost of such movement in one embodiment. In another embodiment, the movement information includes human determinations, such as flight time rules mandated by any appropriate governing body (such as the FAA) and pilot and/or stewardess availability.

The asset is deployed based on the priority factors, departure information, and movement information at step 140. In one embodiment, each of the priority factors, departure information, and movement information is associated with a weighting factor based on a configuration of the system. For example, priority factors can be weighted heavier in the calculation, or weighted lighter.

In another embodiment, the deployment of the asset is further based upon the number of users. For example, 6 lower priority users can be assigned use of the asset over a single higher priority user.

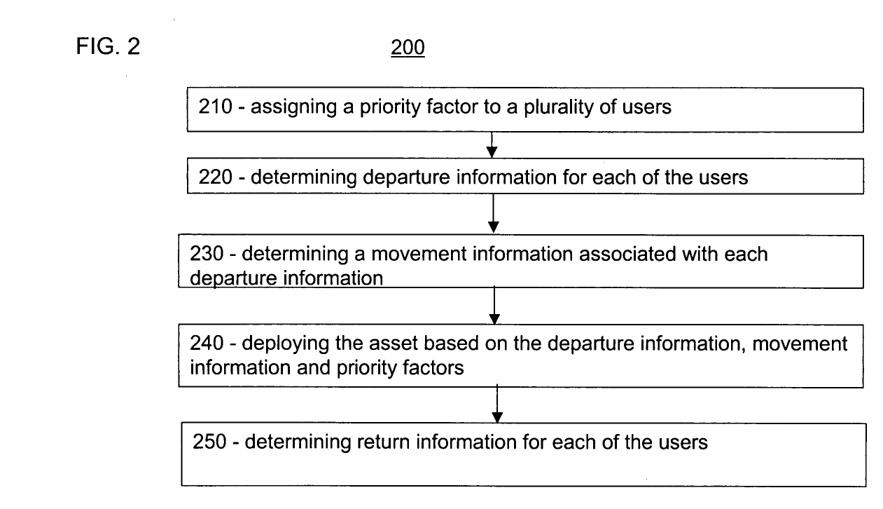

FIG. 2 illustrates another embodiment of a method 200 for financing a mobile asset, in accordance with one embodiment of the invention. Method 200 begins at 210 by assigning a priority factor to a plurality of users. In one embodiment, step 210 is implemented as in step 110. Departure information is determined for each of the plurality of users at step 220. In one embodiment, step 220 is implemented as in step 120. Movement information for each user is determined at step 230. In one embodiment, step 230 is implemented as in step 130. The asset is deployed based on the priority factors, movement information, and departure information at step 240. In one embodiment, step 240 is implemented as in step 140.

Return information is determined for each of the users at step 250. Determining return information is based on any actions that must be taken to deliver the users from their destination information to their next destination. For example, the next destination may be home, or another destination. Determination of return information can include a determination of priority information, cost factors, destination information, and movement information, in one embodiment. In another embodiment, determination of return information comprises determining a method to return the asset to a home base or a fixed location. Determining return information can thus return pilots and stewardesses home as well as enable maintenance.

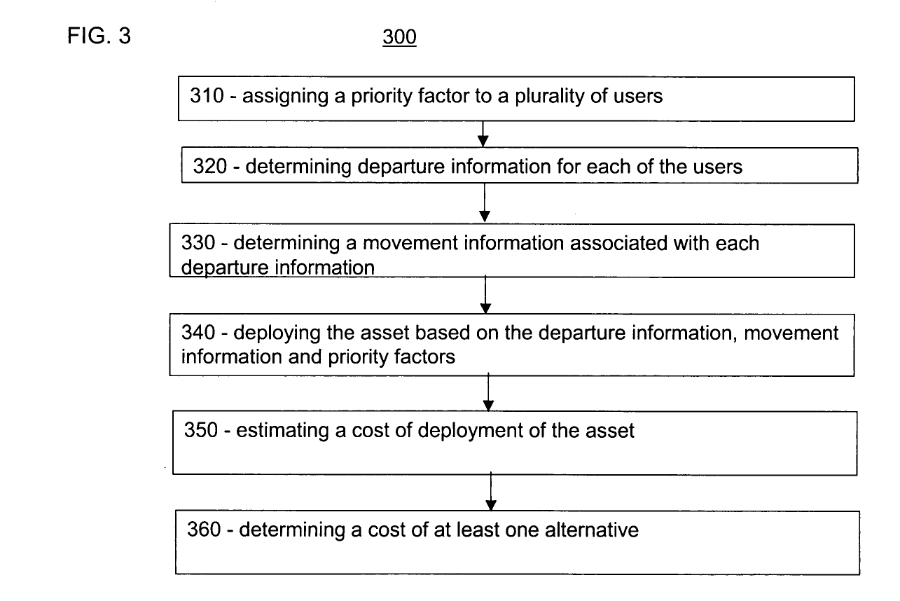

FIG. 3 illustrates another embodiment of a method 300 for financing a mobile asset, in accordance with one embodiment of the invention. Method 300 begins at 310 by assigning a priority factor to a plurality of users. In one embodiment, step 310 is implemented as in step 110. Departure information is determined for each of the plurality of users at step 320. In one embodiment, step 320 is implemented as in step 120. Movement information for each user is determined at step 330. In one embodiment, step 330 is implemented as in step 130. The asset is deployed based on the priority factors, movement information, and departure information at step 340. In one embodiment, step 340 is implemented as in step 140.

A cost of deployment of the asset is estimated at step 350. Cost of deployment includes, but is not limited to, cost of human assets such as a pilot and/or stewardess, fuel costs, insurance costs, overhead costs, maintenance costs, landing fees, overnight fees, food and beverage costs, entertainment costs, business supply costs, taxes, and other costs associated with deployment of the asset. Cost of deployment is determined on an hourly basis in one embodiment. In another embodiment, the cost of deployment is determined for each user. Determining the cost of deployment on a user-by-user basis enables comparison of the costs amongst the users, and deployment of the asset is, in one embodiment, based in part on the cost of deployment for each user.

A cost of at least one alternative is determined at step 360. Determining the cost of an alternative includes, but is not limited to, determining a common carrier cost based on the departure information. Determining the cost of an alternative can also comprise determining a distance associated with the destination, and determining a ‘mileage’ cost for the travel, wherein the cost of the alternative is determined by multiplying the distance by the predetermined mileage cost to determine the cost. As used herein, miles (and mileage) includes any measurement of distance, such as, but not limited to, kilometers. A predetermined mileage cost is, for example, the federally approved mileage reimbursement rate ($0.325 for example).

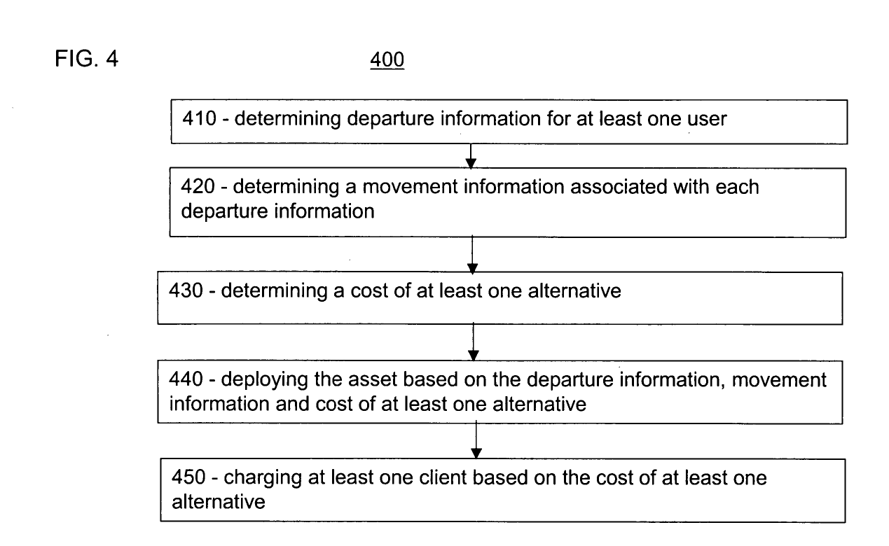

FIG. 4 illustrates one embodiment of a method 400 for financing a mobile asset in accordance with the invention. Method 400 begins by determining departure information for at least one user. The user can be an employee, agent or otherwise known to the financing entity. The departure information can be any information relating to the users starting point for their use of the mobile asset, such as a current or future location, departure time, destination, number of other passengers, or other such information. In one embodiment, the departure information is determined as in steps 120, 220, or 320.

At step 420, movement information associated with each departure information is determined. Movement information relates to any movement of the mobile asset that would be appropriate to service the users departure information. For example, if the asset were currently located in New York City, while a user's departure information required the asset to be in Chicago, the movement information would note the travel between New York City, as well as information associated with that movement, such as the time to travel, the costs of that travel (such as fuel, landing fees, pilot and service salaries, insurance, etc.)

Costs of at least one alternative are determined at step 430. Costs of the alternative are based on the departure information, and estimate a potential cost of meeting the departure information in the event that the mobile asset is not used. For example, commercial airlines can provide an alternate method of providing travel to the user, and this cost is determined. The cost of each alternative can include direct costs, such as the airfare or cost of a rental car, as well as indirect costs. Indirect costs include salary or billing rates of the user for the travel time, food and/or entertainment costs, hotel or other lodging costs depending on the itinerary for the alternative travel, a cost factor to account for extra time or expenses made necessary by the use of the alternative methods for travel. Other costs can also be included in the calculations.

The mobile asset is deployed based on the departure information, movement information and cost of at least one alternative at step 440. A weighting factor can be instituted to weight each factor (departure information, movement information, and cost of at least one alternative) depending on a design choice. Use of a weighting factor can result in over or under inclusion of any particular factor, as chosen by the designer.

At step 450, at least one client is charged expenses based on the deployment of the mobile asset. In one embodiment, the client is any that receives goods or services from the entity financing the mobile asset. For example, a client can be a client of a law firm, consulting firm, or accountant firm. In one embodiment, the client is charged the actual costs of the mobile asset deployment. In another embodiment, the client is charged based on the costs of at least one alternative. In embodiments wherein the client is charged based on the costs of at least one alternative, the charge may be based on a percentage of the costs of the alternative. For example, if the cost to service the user's travel would be $1000.00 on a common carrier, the client may be charged 95% of the common carrier cost. In another example, the client may be charged 105% of the common carrier cost. The percentage may vary from substantially zero percent to any percent deemed appropriate, and can exceed 100%. In another example, the client is charged the actual costs of the mobile asset deployment in the event that the actual costs are less than the total common carrier or alternative costs. In another embodiment, the client is charged the average between the alternative and actual costs.

In one embodiment, a travel schedule is published to at least one publication recipient. The publication can include any appropriate information such a destination schedule including location, destination, and time of departure and/or arrival for the mobile asset. For example, in one embodiment, a RSS feed is employed to publish a schedule. In one embodiment, the schedule includes a cost of riding the mobile asset to persons other than the plurality of users. For example, the operator of a mobile asset has determined that the asset will travel from Chicago, Ill. (ORD) to San Francisco, Calif. (SFO), leaving at 10 PM on Tuesday, but with fewer passengers than capacity. Based on such a determination, the operator publishes to, for example, previous or other users, the schedule. In one embodiment, the schedule includes a cost to participate in using the mobile asset. In the ORD-SFO example, the publication can include cost information indicating the cost to additional users to travel on the asset. The cost to other users can reflect a nominal cost, a differential cost (i.e. the additional costs associated with additional passengers such as fuel, refreshments, etc), a cost based on a cost alternative travel arrangements (i.e. common carrier costs), or a cost responsive to anticipated profit. As used herein, an itinerary includes information indicative of a departure time, arrival time, departure city, arrival city, and/or number of available seats.

In a further embodiment, the publication can be directed to particular persons who have requested a particular itinerary. For example, a person can register their desire to travel ORD-SFO at a particular time, and in the event that the mobile asset is to travel that route, the registered person is notified of the availability of the travel. The registered person may be charged or the travel may be provided without charge. In one embodiment, the cost determination is based on the priority factor of the registered subscriber. In one embodiment, a registered subscriber can pay a fee to increase their priority factor. In another embodiment, the existence of registered users affects the determination of the mobile asset itinerary. In one embodiment, the asset is deployed based on the existence and/or number of registered users. In one embodiment, the deployment of the asset is additionally based on whether the deployment will be published. In another embodiment, the deployment is based on whether at least one other person has registered a desire to utilize the itinerary. In yet another embodiment, the deployment is based on additional revenue to be generated based on use of the mobile asset by registered persons.

For example, a large company has a group of 3 lawyers traveling between ORD and SFO to attend a deposition. In addition, two consultants working on behalf of the company are also traveling from ORD to SFO on client business. Additionally, one accountant is traveling from ORD to SFO on client business. In this example, the mobile asset holds at least 6 seats. Based on the priority factor assigned to the lawyers, the company determines that the asset will deploy to convey the lawyers from ORD to SFO at a time in particular. Based on this decision, the company publishes the information to the consultants and to the accountant. The company may offer use of the mobile asset to the consultants and the accountant without charge or with a charge. In another embodiment, the company only determines to deploy the asset based on polling at least one of the other users and determining that the other user will pay to utilize the asset. In one embodiment, the other, putative, user is not traveling on business related to the owner of the mobile asset. In another example, one of the lawyers is traveling to SJO (an airport near SFO), and deployment is based on the inclusion of nearby destinations. The exemplary airports described herein are exemplary only, and any airport can be used. Additionally, depending on feasibility, seaplanes can land on any appropriate body of water, and need not utilize an airport facility.

The determinations made herein can be made with a centralized, or de-centralized, system. For example, the determinations can be made at a central data center. In another example, the determination is made with use of a peer-to-peer decentralized network. In another example, regional offices make the determinations. The systems can operate using any appropriate tools, including computers including computer readable media including computer readable code to make the determinations or take the steps disclosed herein.

The present invention may be embodied in other specific forms without departing from its spirit or essential characteristics. The described embodiments are to be considered in all respects only as illustrative and not restrictive.

I claim:

1) A method of deploying a mobile asset, the method comprising:
assigning a priority factor to a plurality of users;
determining departure information for each of the users;
determining a movement information associated with each departure information; and
deploying the asset based on the departure information, movement information and priority factors.

2) The method of claim 1 wherein the departure information comprises a departure location and an arrival time and location.

3) The method of claim 1 further comprising determining return information for each of the users.

4) The method of claim 3 wherein the return information comprises a return time.

5) The method of claim 1 wherein the priority factor is established based on the identity of the users.

6) The method of claim 1 wherein the priority factor is established based on the number of users associated with the departure information.

7) The method of claim 1 further comprising:
estimating a cost of deployment of the asset; and
determining a cost of at least one alternative.

8) The method of claim 7 wherein estimating the cost of deployment includes at least one factor selected from the group consisting of mortgage payments, fuel costs, operator costs, training costs, depreciation costs, appreciation estimates, and professional fees associated with at least one user,

9) The method of claim 7 wherein deploying the asset comprises comparing the cost of at least one alternative to the cost of deployment.

10) The method of claim 1 wherein the mobile asset is an aircraft.

11) A method of operating a mobile asset, the method comprising:
determining departure information for at least one user;
determining a movement information associated with each departure information;
determining a cost of at least one alternative;
deploying the asset based on the departure information, movement information and cost of at least one alternative; and
charging at least one client based on the cost of at least one alternative.

12) The method of claim 11 wherein charging at least one client comprises applying a factor to the cost of at least one alternative.

13) The method of claim 12 wherein the factor is a number greater than 0 and less than or equal to 1.

14) The method of claim 12 wherein charging at least one client comprises charging the client based on an average cost of alternatives.

15) The method of claim 12 wherein the cost of at least one alternative is determined from a commercial air carrier.

16) The method of claim 12 wherein the asset is an aircraft.

17) A system of operating a mobile asset, the system comprising:
means for determining departure information at least one user;
means for determining a movement information associated with each departure information;
means for determining a cost of at least one alternative;
means for deploying the asset based on the departure information; and
means for charging at least one client based on the cost of at least one alternative.
